(19) United States
(12) Patent Application Publication
(10) Pub. No.: US 2013/0083727 A1
(43) Pub. Date: Apr. 4, 2013

(54) MOBILE COMMUNICATION SYSTEM, MOBILE STATION AND METHOD FOR SETTING HOLDING PERIOD OF CONNECTION INFORMATION

(71) Applicant: Naritoshi SAITO, Hino (JP)

(72) Inventor: Naritoshi SAITO, Hino (JP)

(73) Assignee: FUJITSU MOBILE COMMUNICATIONS LIMITED, Kawasaki-shi (JP)

(21) Appl. No.: 13/605,817

(22) Filed: Sep. 6, 2012

(30) Foreign Application Priority Data
Sep. 30, 2011 (JP) 2011-216386

(51) Int. Cl. H04W 4/00

(52) U.S. Cl. 370/328

(57) ABSTRACT

In a mobile communication system, a mobile station notifies a first base station of a first holding period when a first mode, in which the mobile station performs wireless communication with one of the first base station and a second base station, is set, and notifies the first base station of a second holding period which is longer than the first holding period when a second mode, in which the mobile station performs wireless communication with the first base station and does not performs wireless communication with the second base station, is set. The first base station discards connection information when the notified holding period has elapsed after the mobile station is unable to perform the wireless communication with the first base station.

### CROSS-REFERENCE TO RELATED APPLICATION

This application is based upon and claims the benefit of priority of the prior Japanese Patent Application No. 2011-216386, filed on Sep. 30, 2011, and the entire contents of which are incorporated herein by reference.

### FIELD

The embodiments discussed herein are related to a mobile station which is capable of performing wireless communication selectively with any of a plurality of base stations in conformity with different wireless communication standards, a mobile communication system including such a mobile station and a method for setting a holding period of connection information.

### BACKGROUND

In a mobile communication system, a mobile station which complies with a plurality of wireless communication standards has been developed. For example, a commercialized mobile station is available which can perform wireless communication selectively utilizing a Mobile WiMAX which is one of the “Worldwide Interoperability for Microwave Access (WiMAX)” standards and is defined as IEEE 802.16e-2005, and CDMA2000 1xEV-DO Rev. A. Hereinafter, a mobile station which complies with the plurality of wireless communication standards is referred to as a multimode-compatible mobile station for the sake of simplicity. For example, when the multimode-compatible mobile station can perform the wireless communication with a base station corresponding to a wireless communication standard in which communication speed is relatively fast whereas available area is relatively small (hereinafter, referred to as the base station for high speed communication, for the sake of simplicity), the multimode-compatible mobile station performs the wireless communication with the base station for high speed communication. On the other hand, when the multimode-compatible mobile station becomes unable to perform the wireless communication with base station for high speed communication, the multimode-compatible mobile station switches a connection destination to the base station corresponding to a wireless communication standard according to which communication speed is relatively slow whereas available area is relatively large (hereinafter, referred to as base station for low speed communication, for the sake of simplicity). Thus, an operational mode, in which the multimode-compatible mobile station dynamically switches communication standards to be used according to a communication status among a plurality of wireless communication standards, is hereinafter referred to as a multimode.

Some of the multimode-compatible mobile stations may be set to allow the wireless communication only with a base station for high speed communication, for example, according to a user's operation. An operational mode, in which the multimode-compatible mobile station uses a specific communication standard among from the plurality of wireless communication standards as described, is hereinafter referred to as a dedicated mode.

Moreover, a technique is proposed that providing notification regarding the setting information as to predetermined operation from a mobile station to a base station, causes the base station to switch setting related to the predetermined operation (for example, refer to Published Japanese Translation of PCT International Publication for Patent Application (Kohyo) No. 2008-508779). In a communication system disclosed in Published Japanese Translation of PCT International Publication for Patent Application (Kohyo) No. 2008-508779, a paging cycle actually assigned to a mobile terminal is calculated using a desired paging cycle requested from the mobile terminal and a basic paging cycle currently used in common in the paging group to which a serving base station for the mobile terminal belongs.

### SUMMARY

When the multimode-compatible mobile station operates in the dedicated mode, the base station for high speed communication preferably holds the connection information which is used for connecting with a mobile station for a relatively long time, even if the mobile station is unable to communicate. This is because it allows a reduction in the time required for the mobile station to resume the communication with the base station for high speed communication, when the mobile station and the base station for high speed communication are able to communicate again. On the other hand, when the multimode-compatible mobile station operates in the multimode, the base station for high speed communication preferably discards the connection information within a relatively short time, even if the mobile station is unable to communicate. This is because, there is a high possibility that the mobile station, which has been unable to communicate with the base station for high speed communication, performs the wireless communication through the base station for low speed communication, and the mobile station for high-speed communication can utilize the radio resource assigned to the mobile station to other mobile stations in this case.

However, the base station for high speed communication has not been able to know whether the mobile station is operating in the dedicated mode or in the multimode. Therefore, the base station for high speed communication has not been able to switch the holding period for the connection information in accordance to the operational mode according to which the multimode-compatible mobile station is performing. Moreover, even in the technique disclosed in Published Japanese Translation of PCT International Publication for Patent Application (Kohyo) No. 2008-508779, since the mobile station does not transmit information required for the mobile station to set the holding period of the connection information to the base station for high speed communication, the base station for high speed communication is not able to set a suitable holding period.

For that reason, it is desirable to provide a mobile communication system in which a base station can change a period for holding the connection information, in accordance with setting regarding a change of wireless communication standard which the mobile station, in conformity with a plurality of wireless communication standards, actually uses.

According to one embodiment, a mobile communication system including a mobile station, a first base station and a second base station other than the first base station is provided. In the mobile communication system, the mobile station notifies the first base station of a first holding period when a first mode in which the mobile station selects one of the first base station and the second base station and performs wireless communication with the selected base station is set, on the other hand, notifies the first base station of a second holding period which is longer than the first holding period when a second mode in which the mobile station performs wireless communication with only first base station is set.

The first base station discards connection information used for connecting the mobile station with the first base station at the time when the first holding period has elapsed after the mobile station has become unable to perform the wireless communication with the first base station when the first holding period is notified from the mobile station, and on the other hand, discards the connection information at the time when the second holding period has elapsed after the mobile station has become unable to perform the wireless communication with the first base station when the second holding period is notified from the mobile station.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a schematic diagram of a mobile communication system according to one embodiment;

FIG. 2 is a drawing illustrating an example of connection information;

FIG. 3 is a drawing illustrating an example of a sequence chart where the base station for high speed communication determines a holding period;

FIG. 4 is a drawing illustrating another example of a sequence chart where the base station for high speed communication determines the holding period;

FIG. 5 is a drawing illustrating still another example of a sequence chart where the base station for high speed communication determines the holding period;

FIG. 6 is a schematic diagram of a mobile station according to one embodiment;

FIG. 7 is an operational flowchart of a setting process of holding period, which is performed by a communication control unit of the mobile station;

FIG. 8 is a schematic diagram of the base station for high speed communication; and

FIG. 9 is an operational flowchart of a setting process of holding period, which is performed by a communication control section of the base station for high speed communication.

### DESCRIPTION OF EMBODIMENTS

Hereinafter, a mobile communication system according to one embodiment will be explained with reference to accompanying drawings. The mobile communication system includes a base station for high speed communication, a base station for low speed communication, and a multimode-compatible mobile station which supports a first and a second wireless communication standard. The base station for high speed communication complies with the first wireless communication standard and on the other hand, the base station for low speed communication complies with the second wireless communication standard according to which transmission speed is relatively slow rather than that according to the first wireless communication standard. The multimode-compatible mobile station notifies the base station for high speed communication of a holding period of connection information according to the set operational mode, when the operational mode is set to any of a multimode or a dedicated mode. The base station for high speed communication holds the connection information about the mobile station until the notified holding period has elapsed, even if communication with the multimode-compatible mobile station become impossible.

Note that, in this specification, the terms “high speed” and “low speed” do not represent absolute speeds of the wireless communication. The term “high speed” represents that the maximum communication speed of one wireless communication standard, with which equipment called high-speed complies, is relatively faster than the maximum communication speed of another wireless communication standard. Likewise, the term “low speed” represents that the maximum communication speed of one wireless communication standard, which equipment called low-speed complies with, is relatively slower than the maximum communication speed of another wireless communication standard. The base station for high speed communication may be referred to as a first base station, and the base station for low speed communication may be referred to as a second base station. The communication speed of the first base station may be faster than that of the second base station, whereas an area in which the first base station can be used may be narrower than an area for the second base station. Moreover, the communication speed of the second base station may be slower than that of the first base station, whereas the area in which the second base station can be used may be larger than an area for the first base station.

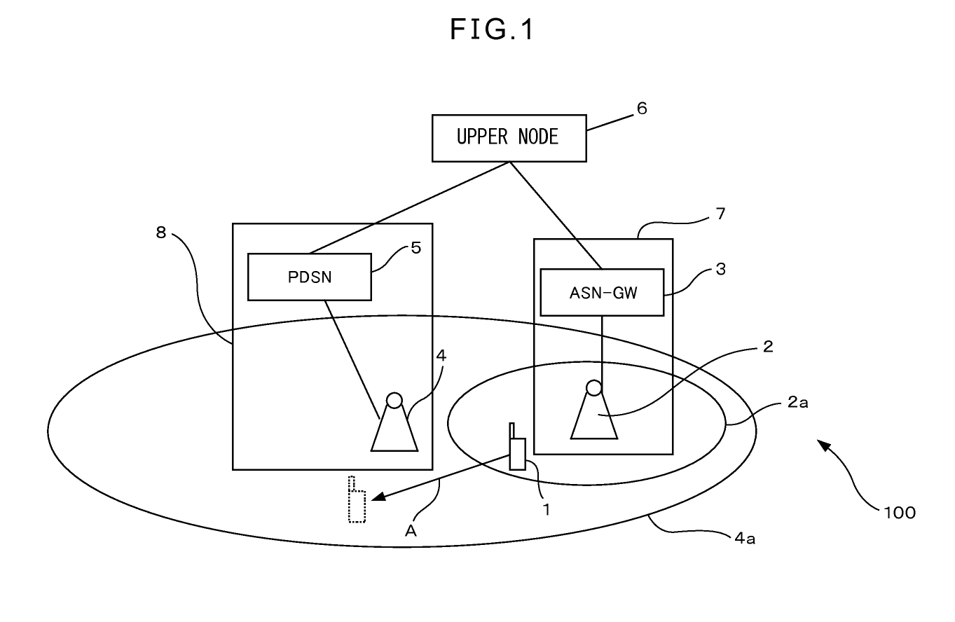

FIG. 1 is a schematic diagram of a mobile communication system 100 according to one embodiment. The mobile communication system 100 includes a mobile station 1, a base station for high speed communication 2, an Access Service Network Gateway 3, a base station for low speed communication 4, a packet data serving node 5, and an upper node 6. In FIG. 1, as an example, two sets of base stations are included in the mobile communication system 100. However, the number of the base stations for high speed communication and the base stations for low speed communication included in the mobile communication system 100 may be plural respectively. Furthermore, the number of the mobile stations included in the mobile communication system 100 is not limited to one set.

The base station for high speed communication 2 and the Access Service Network Gateway (ASN-GW) 3 form a high speed wireless access network 7 in conformity with the first wireless communication standard. For example, the first wireless communication standard is mobile WiMAX specified as IEEE 802.16e-2005 or WiMAX2 specified as IEEE 802.16m. The base station for high speed communication 2 is an apparatus which relays communication between the mobile station 1 and the upper node 6. The ASN-GW 3 is disposed between the base station for high speed communication 2 and the upper node 6, and has functions such as radio resource administration, position registration, authentication and Quality Of Service (QoS) administration.

On the other hand, the base station for low speed communication 4 and the packet data serving node (PDSN) 5 form a low speed wireless access network 8 in conformity with the second wireless communication standard, of which wireless communication speed to the mobile station 1 is slower than that of the first wireless communication standard. The second wireless communication standard is Wideband Code Division Multiple Access (W-CDMA), CDMA2000 1X, or CDMA2000 1X EV-DO, for example. The base station for low speed communication 4 may comply with both of CDMA2000 1X and CDMA2000 1X EV-DO. The base station for low speed communication 4 relays the communication between the mobile station 1 and the upper node 6. The PDSN 5 terminates an Internet Protocol (IP) network which is a network on the upper node 6 side. The low speed wireless access network 8 may include a wireless network controller (not illustrated) which is connected to the base station for low speed communication 4 and the PDSN 5 and has functions such as radio resource administration, position registration, authentication and Quality Of Service (QoS) administration.

The upper node 6 is an apparatus which relays communication between each wireless access network and a core network. The upper node 6 includes, for example, a server with a function of a Home Agent (HA) which manages the position information on routing and the mobile station 1, and a server with a function of Authentication, Authorization and Accounting (AAA).

A cell 2a covered by the base station for high speed communication 2 is narrower than a cell 4a covered by the base station for low speed communication 4, and is included in the cell 4a. When the mobile station 1 is located in the cell 2a, the mobile station 1 can perform the wireless communication with the base station for high speed communication 2. However, as illustrated by an arrow A in FIG. 1, when the mobile station 1 moves outside the cell 2a, the mobile station 1 becomes unable to perform the wireless communication with the base station for high speed communication 2. The mobile station 1 and the base station for high speed communication 2 hold connection information during a certain subsequent period, so that the wireless communication can be immediately resumed utilizing a former communication session when the mobile station 1 moves into the cell 2a again. The connection information is for connecting the mobile station 1 with the core network through the high speed wireless access network 7. When the mobile station 1 does not move into the cell 2a even if the certain period has elapsed, the mobile station 1 and the base station for high speed communication 2 discard the connection information. The mobile station 1 switches a communication path from a path through the base station for high speed communication 2 to a path through the base station for low speed communication 4.

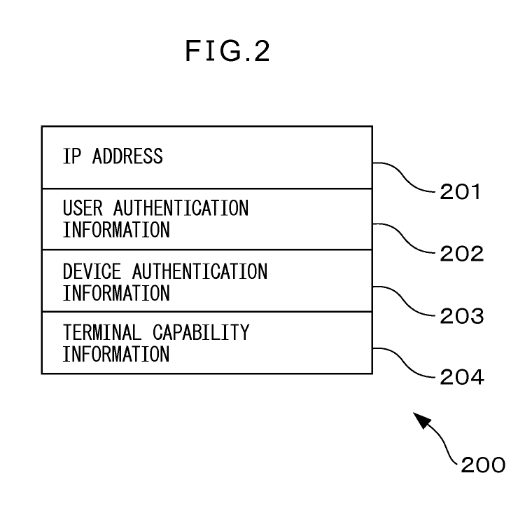

FIG. 2 is a drawing illustrating an example of the connection information. The connection information 200 includes an IP address 201 assigned to the mobile station 1, user authentication information 202 and a device authentication information 203 which are information for authenticating a user of the mobile station 1 and the mobile station 1, and a terminal capability information 204 which represents communication capability of the mobile station 1. The terminal capability information 204 includes, for example, a flag indicating a modulation and demodulation manner which the mobile station 1 supports, and the number of signals for (or a size of) Fast Fourier Transform (FFT) used for multiplexing the signals modulated according to Orthogonal Frequency Division Multiplexing (OFDM) manner. Furthermore, the terminal capability information 204 may include information such as the number of receiving antennae for utilizing Multiple Input Multiple Output (MIMO) technique, a flag indicating whether or not it complies with Space Time Coding (STC) mode, and the number of transmitting antennae.

In this embodiment, the mobile station 1 is a multimode-compatible mobile station, and can be set by a user's operation to one of the multimode and a dedicated mode utilizing only the base station for high speed communication 2. In the multimode, the mobile station 1 selectively utilizes one of the base station for high speed communication 2 and the base station for low speed communication 4 in order to transmit and receive data. In this case, when the mobile station 1 moves outside the cell 2a covered by the base station for high speed communication 2, it is preferable to switch a connection destination of the mobile station 1 to the base station for low speed communication 4 within a first holding period which is relatively short. Moreover, the mobile station 1 and the base station for high speed communication 2 preferably discard the connection information at the time when the first holding period has elapsed. Accordingly, when the mobile station 1 becomes unable to communicate with the base station for high speed communication 2, the mobile station 1 can continue the communication with relatively short waiting time, although the communication speed is declined. The base station for high speed communication 2 and the ASN-GW3 can release a wireless resource prepared for the mobile stations 1 within a relatively short time. This allows improved efficient use of the wireless resource.

On the other hand, in the dedicated mode, even if the mobile station 1 moves outside the cell 2a, the mobile station 1 does not switch the communication path. Therefore, the mobile station 1 and the base station for high speed communication 2 preferably continue to hold the connection information during a second holding period which is longer than the first holding period, so that the mobile station 1 can immediately resume the communication when the mobile station 1 moves into the cell 2a again. The first holding period is set to, for example, 5 seconds to 10 seconds, and on the other hand, the second holding period is set to, for example, 30 seconds to 50 seconds.

In order to determine the holding period of the connection information about the mobile station 1 by the base station for high speed communication 2, the mobile station 1 notifies the base station for high speed communication 2 of the holding period corresponding to the operational mode which is set. For example, the mobile station 1 notifies the base station for high speed communication 2 of the holding period corresponding to the operational mode which is set, when the mobile station 1 transits to the idle mode. The idle mode is an operating state in which the mobile station receives radio signals including a calling signal to notify whether or not an incoming call exists from the base station in the wireless communication. For example, the mobile station 1 utilizes Paging Cycle in a deregistration request (DREG-REQ) message as a parameter indicating the holding period, the deregistration request being defined by the mobile WiMAX or WiMAX2 and requesting to transit to the idle mode.

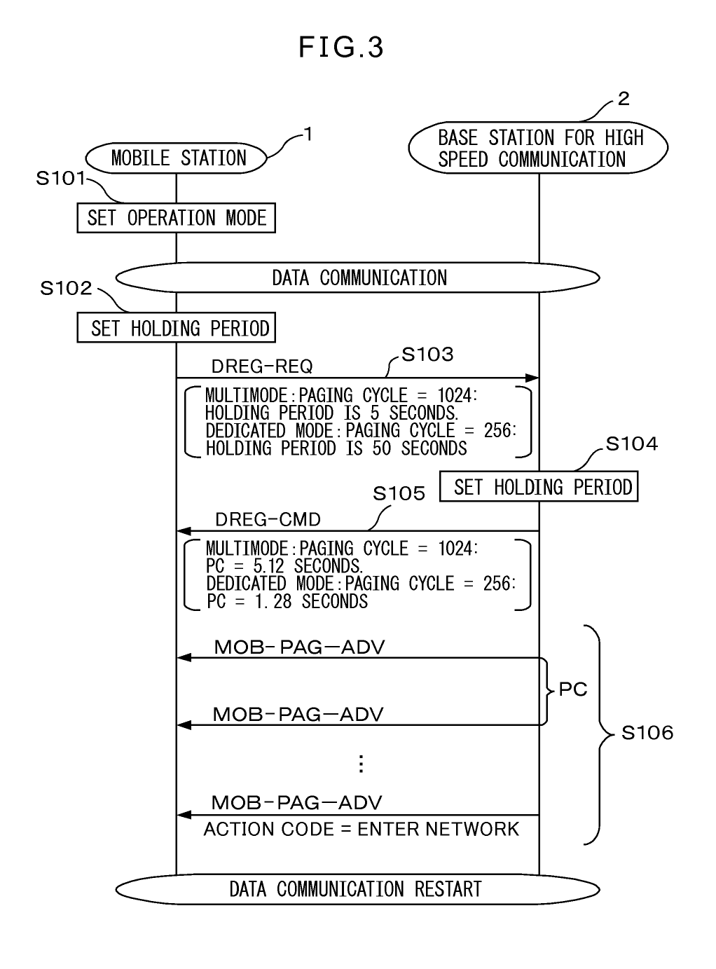

FIG. 3 is a drawing illustrating an example of a sequence chart where the base station for high speed communication 2 determines the holding period.

The mobile station 1 sets the operational mode to one of the multimode and the dedicated mode according to the user's operation, for example (step S101). When the operational mode is set, the mobile station 1 sets the holding period corresponding to set the operational mode (step S102). When the mobile station 1 is located in the cell covered by the base station for high speed communication 2 and, for example, the program executed in the mobile station 1 requests to transmit or receive data, the mobile station 1 performs data communication with the base station for high speed communication 2 by radio.

After that, when the mobile station 1 intends to transit to the idle mode, the mobile station 1 transmits the deregistration request (DREG-REQ) message to the base station for high speed communication 2 (step S103). When the operational mode of the mobile station 1 is set to the multimode, the mobile station 1 sets the Paging Cycle parameter included in the DREG-REQ message to a value indicating the first holding period (for example, for 5 seconds), such as ‘1024’. On the other hand, when the operational mode of the mobile station 1 is set to the dedicated mode, the mobile station 1 sets the Paging Cycle parameter included in the DREG-REQ message to a value indicating the second holding period (for example, for 50 seconds), such as ‘256’.

The base station for high speed communication 2 performs, when receiving the DREG-REQ message, a setting process of the holding period with reference to the Paging Cycle parameter included in the message (step S104).

The base station for high speed communication 2 may change a paging cycle which is a transmission cycle of the calling signal according to the holding period, that is, according to the operational mode of the mobile station 1. For example, the base station for high speed communication 2 sets the paging cycle to relatively long period such as 5.12 seconds in order to suppress the power consumption of the mobile station 1, when the mobile station 1 is operating in the multimode. On the other hand, when the mobile station 1 is operating in the dedicated mode, the paging cycle is set to relatively short period such as 1.28 seconds, so that the mobile station 1 can quickly return to an active mode from the idle mode when the incoming call to the mobile station 1 exists. Then, the base station for high speed communication 2 sends back the deregistration command (DREG-CMD) message to the mobile station 1 (step S105). In that case, the base station for high speed communication 2 may set the Paging Cycle parameter included in the DREG-CMD message any of different values depending on the paging cycle PC. For example, when the paging cycle PC is set to 5.12 seconds, the base station for high speed communication 2 set the Paging Cycle parameter included in the DREG-CMD message to ‘1024’. On the other hand, when the paging cycle PC is set to 1.28 seconds, the base station for high speed communication 2 sets the Paging Cycle parameter included in the DREG-CMD message to ‘256’. In this case, the mobile station 1 sets the paging cycle according to the value of the Paging Cycle parameter included in the message when receiving the DREG-CMD message.

After that, the calling signal is transmitted to the mobile station 1 from the base station for high speed communication 2 at the set paging cycle (step S106). The calling signal may be, for example, a MOB-PAG-ADV message, which is transmitted through a broadcast channel in the mobile WiMAX or WiMAX2. If a value of Action Code parameter included in the MOB-PAG-ADV message is a value of ‘Enter Network’ which indicates existence of the incoming call, the mobile station 1 transits to the active mode from the idle mode and resumes the data communication through the base station for high speed communication 2.

According to modifications, a parameter for notifying the holding period corresponding to the operational mode of the mobile station 1 may be newly added to the DREG-REQ message.

A parameter for notifying the mobile station 1 of the holding period which the base station for high speed communication 2 actually set may be added to the DREG-CMD message.

According to another modification, a new message may be used for notifying the base station for high speed communication 2 of the holding period corresponding to the operational mode of the mobile station 1 from the mobile station 1. For example, in this modification, the message for notifying the base station for high speed communication 2 of the holding period from the mobile station 1 is referred to as Active Session Retention Req, and the message for notifying the mobile station 1 of the holding period from the base station for high speed communication 2 is referred to as Active Session Retention CMD. The Active Session Retention Req message and the Active Session Retention CMD message are exchanged between the mobile station 1 and the base station for high speed communication 2, for example, before requiring that the mobile station 1 transits to the idle mode.

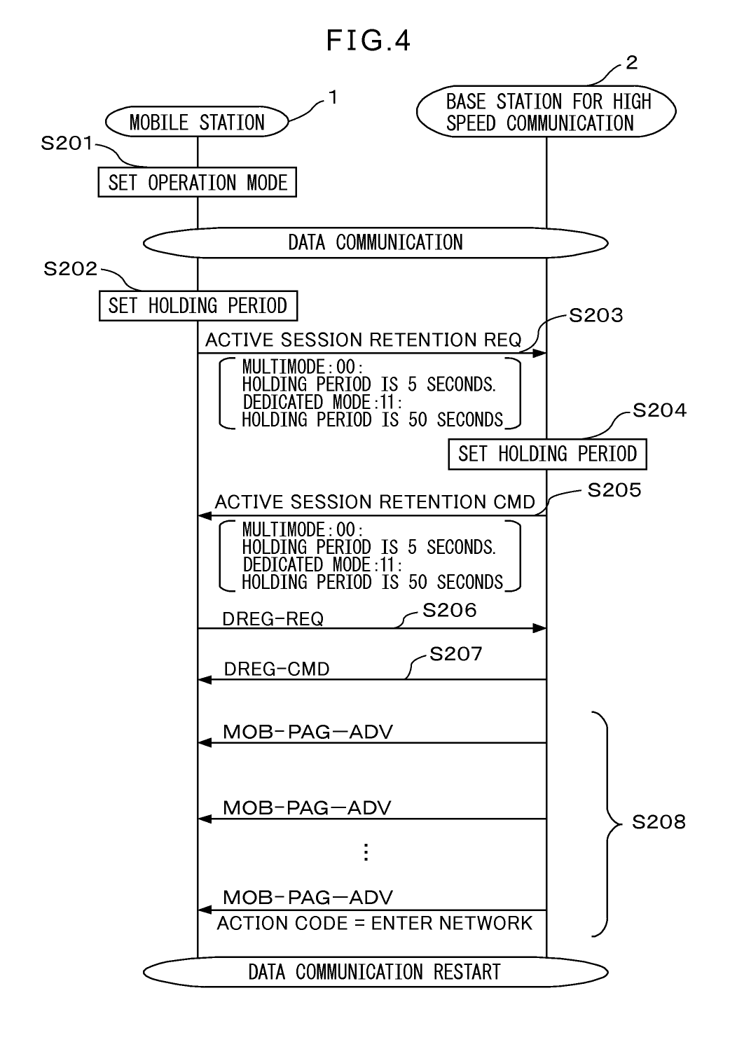

FIG. 4 is a drawing illustrating another example of a sequence chart where the base station for high speed communication 2 determines the holding period.

The mobile station 1 sets the operational mode to one of the multimode and the dedicated mode according to the user's operation, for example (step S201). When the operational mode is set, the mobile station 1 sets the holding period corresponding to the set operational mode (step S202).

After that, the mobile station 1 transmits the Active Session Retention Req message to the base station for high speed communication 2, for example, before trying to transit to the idle mode and during data communication with the base station for high speed communication 2 by radio (step S203). The Active Session Retention Req message includes the parameter indicating the holding period. For example, the parameter is expressed by 2 bits and has a value ‘00’, when the mobile station 1 operates in the multimode and the holding period is set to 5 seconds. On the other hand, the parameter has a value ‘11’ when the mobile station 1 operates in the dedicated mode and the holding period is set to 50 seconds, for example. The parameter indicating the holding period may have a value representing the set holding period on the second time scale.

When the base station for high speed communication 2 receives the Active Session Retention Req message, the base station for high speed communication 2 performs a setting process of the holding period with reference to the parameter included in the message (step S204). Then, the base station for high speed communication 2 sends back the Active Session Retention CMD message to the mobile station 1 (step S205). The Active Session Retention CMD message may also include the parameter indicating the holding period which is set by the base station for high speed communication 2, as with the Active Session Retention Req message.

After that, when the mobile station 1 intends to transit to the idle mode, the mobile station 1 transmits the DREG-REQ message to the base station for high speed communication 2 (step S206). When the base station for high speed communication 2 receives the DREG-REQ message, the base station for high speed communication 2 prepares to cause the mobile station 1 to transit to the idle mode and sends back the DREG-CMD message to the mobile station 1 (step S207). In this modification, the base station for high speed communication 2 may also set the paging cycle in accordance with the holding period and set the Paging Cycle parameter included in the DREG-CMD message to a value indicating the paging cycle.

After that, the calling signal is transmitted to the mobile station 1 from the base station for high speed communication 2 at the set paging cycle until the communication resumes (step S208).

According to still another modification, after the mobile station 1 and the base station for high speed communication 2 perform a synchronization and an initial ranging process, the mobile station 1 and the base station for high speed communication 2 may exchange a message including the parameter indicating the holding period. In this modification, for example, the parameter indicating the holding period is added to an SS Basic Capability-Request (SBC-REQ) message which includes a parameter regarding a physical layer indicating the ability to support by the mobile station 1 and information of authentication-related capability. Likewise, the parameter indicating the holding period may be added to an SS Basic Capability Negotiation Response (SBC-RSP) message which is a response message to the SBC-REQ message.

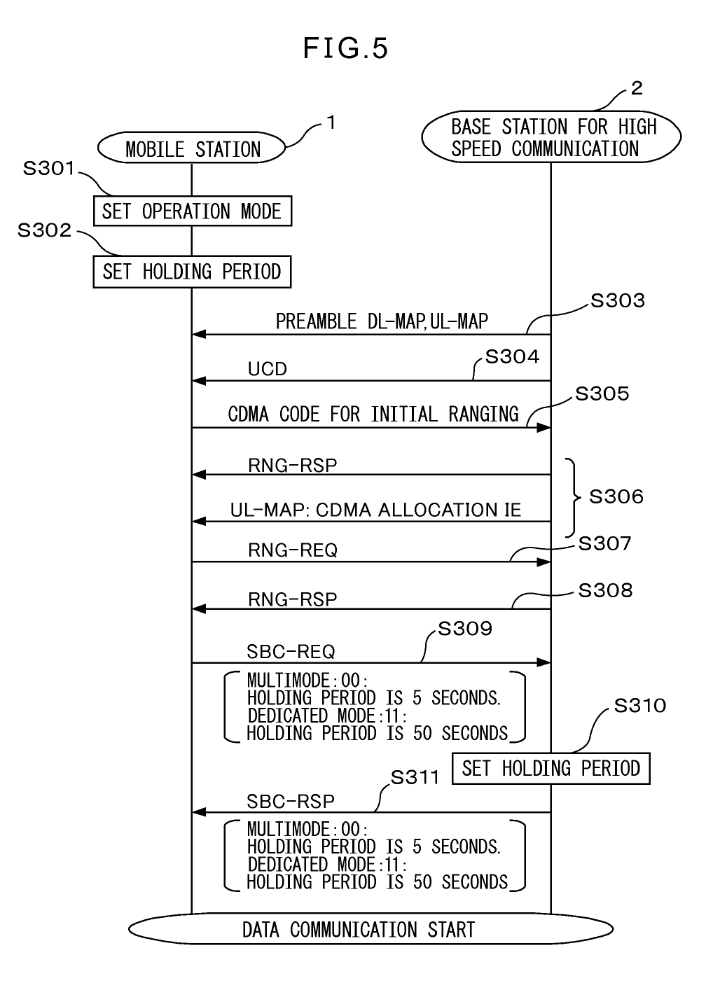

FIG. 5 is a drawing illustrating still another example of a sequence chart where the base station for high speed communication 2 determines the holding period.

The mobile station 1 sets the operational mode to one of the multimode and the dedicated mode according to the user's operation, for example (step S301). When the operational mode is set, the mobile station 1 sets the holding period corresponding to the set operational mode (step S302).

Next, the mobile station 1 receives a preamble, a frame control header and map information on downlink and uplink (DL-MAP, UL-MAP), which are included in the radio signals transmitted from the base station for high speed communication 2 for every constant frame period (for example, 5 milliseconds) (step S303). The mobile station 1 performs a synchronous process with reference to the preamble. Moreover, the mobile station 1 specifies data block in a frame, to which Downlink Channel Descriptor (DCD) and Uplink Channel Descriptor (UCI) are assigned, with reference to the map information. Then, the mobile station 1 receives a radio signal which includes a UCD message from the base station for high speed communication 2 (step S304). The mobile station 1 specifies an initial ranging allocation area, ranging code allocation range and so on with reference to the UCD message. Then, the mobile station 1 transmits a Code Division Multiple Access (CDMA) code for the initial ranging to the base station for high speed communication 2 (step S305).

If the base station for high speed communication 2 succeeds in the initial ranging process, the base station for high speed communication 2 transmits a ranging response (RNG-RSP) message to the mobile station 1. Furthermore, the base station for high speed communication 2 transmits, to the mobile station 1, the UL-MAP which represents CDMA Allocation IE indicating the resource to be assigned to an initial ranging request (RNG-REQ) message (step S306).

The mobile station 1 extracts the CDMA Allocation IE from the received ULMAP and transmits the initial RNG-REQ message using the resource assigned by the CDMA Allocation IE (step S307). The initial RNG-REQ message includes a Media Access Control (MAC) address of the mobile station 1, a requested downlink transmission level and so on. When the base station for high speed communication 2 receives the RNG-REQ message, the base station for high speed communication 2 sends back the RNG-RSP message to the mobile station 1 as a response to the RNG-REQ message (step S308). The RNG-RSP message includes the MAC Address of the mobile station 1, a basic Connection Identifier (CID) assigned so that the mobile station 1 can be identified uniquely by the base station for high speed communication 2 and a primary CID. According to these processes, an initial ranging procedure is completed.

Next, the mobile station 1 transmits a SBC-REQ message to negotiate the basic capability of the mobile station with the base station for high speed communication 2 (step S309). In this modification, the SBC-REQ message includes the parameter indicating the holding period. For example, the parameter is expressed by 2 bits, and has a value ‘00’ when the mobile station 1 operates in the multimode and the holding period is set to 5 seconds. On the other hand, the parameter has a value ‘11’ when the mobile station 1 operates in the dedicated mode and the holding period is set to 50 seconds. In this modification, the parameter indicating the holding period may also have a value representing the set holding period on the second time scale.

When the base station for high speed communication 2 receives the SBC-REQ message, the base station for high speed communication 2 performs a setting process of the holding period with reference to the parameter included in the message (step S310). Then, the base station for high speed communication 2 sends back the SBC-RSP message to the mobile station 1 (step S311). The SBC-RSP message may also include the parameter indicating the holding period which is set by the base station for high speed communication 2, as with the SBC-REQ message.

After that, data communication is started between the mobile station 1 and the base station for high speed communication 2.

In this modification, the base station for high speed communication 2 may also set the paging cycle in accordance with the holding period, and notify the paging cycle to the mobile station 1 using the Paging Cycle parameter of the DREG-CMD message, which is transmitted to the mobile station 1 from the base station for high speed communication 2.

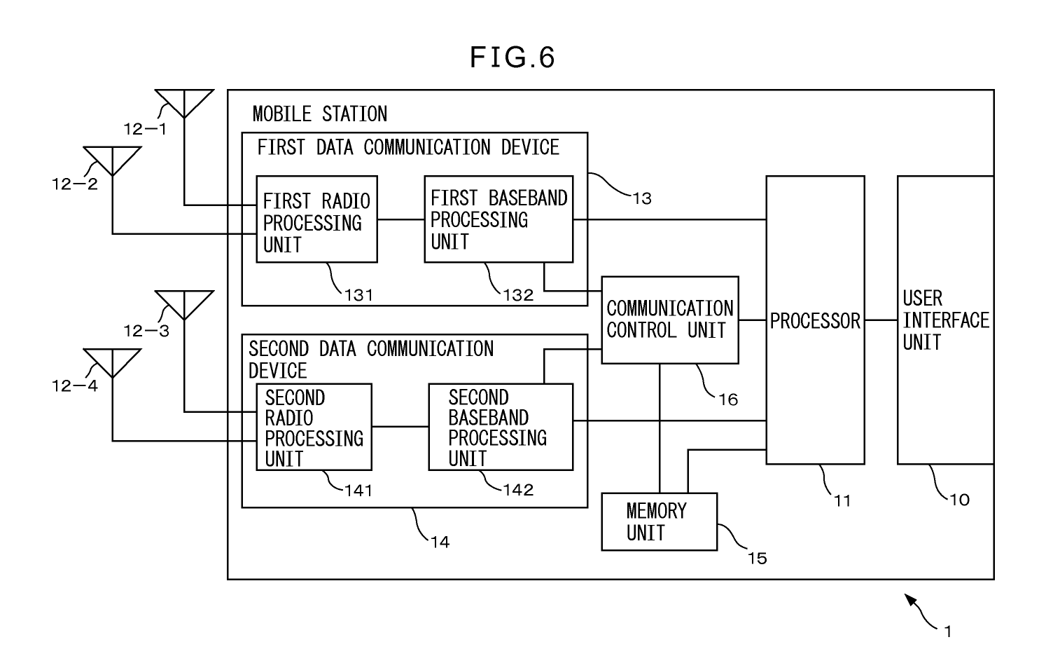

FIG. 6 is a schematic diagram of the mobile station 1. The mobile station 1 is a portable wireless terminal which operates with the electric power supplied from a built-in power supply, such as a smartphone, a personal digital assistant, a mobile router, or a tablet PC. The mobile station 1 includes a user interface unit 10, a processor 11, antennae 12-1 through 12-4, a first data communication device 13, a second data communication device 14, a memory unit 15, and a communication control unit 16. Each of these units included in the mobile station 1 is accommodated in a housing (not illustrated). The mobile station 1 may further include a speaker, a microphone, a camera and an interface circuit for connecting in communicative manner with other equipment.

The user interface unit 10 includes, for example, a display such as a liquid crystal display and an input device provided with a plurality of button switches. Alternatively, the user interface unit 10 may include a touch-panel display in which the display and the input device are integrated. The user interface unit 10 displays the information for display received from the processor 11 on the display. Moreover, the user interface unit 10 transfers, to the processor 11, an input signal according to user's operation to the input device.

In this embodiment, the user can set the operational mode of the mobile station 1 to any of the multimode and the dedicated mode by operating the user interface unit 10. When a setting operation about the operational mode of the mobile station 1 has been performed, the user interface unit 10 transfers a mode signal indicating the set operational mode to the processor 11, as an example of the input signal.

The processor 11 controls entire mobile station 1. The processor 11 executes, for example, an application program in accordance with the input signal due to the user's operation. When the processor 11 performs the data communication by radio in accordance with the application program, the processor 11 receives data included in the radio signals from the base station through the first data communication device 13 or the second data communication device 14. The processor 11 transfers the data to be transmitted to the base station to the first data communication device 13 or the second data communication device 14. Furthermore, the processor 11 transfers the audio signals which are input through the microphone to the second data communication device 14 during a voice call. On the other hand, the processor 11 receives, from the second data communication device 14, the audio signal included in the radio signals received from the base station, and outputs the audio signal through the speaker.

The first data communication device 13 is utilized to perform the data communication with the base station for high speed communication 2 by radio, through the antennae 12-1 and 12-2. Therefore, the antennae 12-1, 12-2, and the first data communication device 13 comply with a wireless communication standard with which the base station for high speed communication 2 comply, such as the mobile WiMAX or WiMAX2.

The first data communication device 13 receives the radio signals including the downlink signals, which are multiplexed in accordance with Orthogonal Frequency Division Multiple Access (OFDMA) manner, from the base station for high speed communication 2, for example. On the other hand, the first data communication device 13 transmits the radio signals including the uplink signals which are multiplexed in accordance with Orthogonal Frequency Division Multiplexing (OFDM) manner. The first data communication device 13 and the base station for high speed communication 2 transmit and receive the radio signals including downlink signals and the radio signals including uplink signals alternately in frame, for example, in accordance with the Time Division Duplexing (TDD) manner. One frame includes a subframe for downlink transmitted to the mobile station 1 from the base station for high speed communication 2, and a subframe for uplink transmitted to the base station for high speed communication 2 from the mobile station 1.

The first data communication device 13 includes a first radio processing unit 131 and a first baseband processing unit 132. The first radio processing unit 131 and the first baseband processing unit 132 may be individual circuits respectively. Alternatively, each of units may be one integrated circuit in which the circuits are integrated.

The first radio processing unit 131 performs processes, such as amplification of the uplink signals and the downlink signals, digital/analog conversion and frequency conversion. On the other hand, the first baseband processing unit 132 performs a process to the uplink signals and the downlink signals with baseband frequency.

With respect to the uplink signals, the first baseband processing unit 132 performs the transmission process to the uplink signals, for example a coding process for error corrections such as a convolutional coding or a turbo coding. Furthermore, the first baseband processing unit 132 modulates the coded uplink signals in accordance with a predetermined modulation method and multiplexes the uplink signals in accordance with the OFDM manner, whereby, the first baseband processing unit 132 generates the subframe for uplink. The first baseband processing unit 132 outputs the subframe for uplink to the first radio processing unit 131.

The first radio processing unit 131 applies digital/analog conversion to the subframe for uplink received from the first baseband processing unit 132, then superimposes the result on a carrier with a radio frequency. The first radio processing unit 131 amplifies the subframe for uplink superimposed on the carrier by a high power amplifier (not illustrated), then outputs the result to the antenna 12-1 through a duplexer (not illustrated). The antenna 12-1 radiates the subframe for uplink as the radio signal.

With respect to the downlink signals, the first radio processing unit 131 receives the radio signals including the subframe for downlink which are received by the antenna 12-1 through the duplexer. The first radio processing unit 131 also receives the radio signals including the subframe for downlink received by the antenna 12-2. Then, the first radio processing unit 131 selects the subframe of which signal intensity is stronger among from the subframes for downlink received from the two antennae respectively. The first radio processing unit 131 amplifies the selected subframe by a low noise amplifier, and superimposes periodic signal with local oscillation frequency on the amplified subframe, whereby, the first radio processing unit 131 converts the frequency of the subframe for downlink into baseband frequency from radio frequency. The first radio processing unit 131 applies the analog/digital conversion to the subframe for downlink with the baseband frequency, and thereafter, transfers the subframe to the first baseband processing unit 132.

Alternatively, when the base station for high speed communication 2 transmits the subframe for downlink from a plurality of antennae in accordance with MIMO technique, the first radio processing unit 131 performs the amplification, the frequency conversion and the analog/digital conversion to the subframe for downlink received by each antenna respectively. Subsequently, the first radio processing unit 131 transfers each subframe to the first baseband processing unit 132.

The first baseband processing unit 132 demodulates each downlink signal included in the subframe for downlink which is received from the first radio processing unit 131. The first baseband processing unit 132 applies an error correction decoding process to the demodulated downlink signal. The first baseband processing unit 132 outputs the decoded downlink signal to the processor 11.

Note that the base station may transmit the downlink signals from a plurality of antennae in accordance with the MIMO technique. In this case, the first baseband processing unit 132 performs a signal separation process in accordance with a minimal mean squared error method or a maximum likelihood estimate method to a set of the downlink signals received simultaneously by the antennae 12-1 and 12-2 respectively, before demodulating each of downlink signals.

The second data communication device 14 is utilized to perform the data communication or the voice communication with the base station for low speed communication 4 by radio through the antennae 12-3 and 12-4. Therefore, the antennae 12-3, 12-4, and the second data communication device 14 comply with the wireless communication standard with which the base station for low speed communication 4 comply, such as cdma 2000 1x and cdma 1x EV-DO. The second data communication device 14, for example, transmits the uplink signals multiplexed in the cdma manner to the base station for low speed communication 4, on the other hand, receives the downlink signals multiplexed in the cdma manner from the base station for low speed communication 4.

The second data communication device 14 includes a second radio processing unit 141 and a second baseband processing unit 142. The second radio processing unit 141 and the second baseband processing unit 142 may be individual circuits respectively. Alternatively, each of units may be one integrated circuit in which those circuits are integrated.

The second radio processing unit 141 performs processes, such as amplification of the uplink signals and the downlink signals, digital/analog conversion and frequency conversion, as with the first radio processing unit 131. On the other hand, the second baseband processing unit 142 performs a process to the uplink signals and the downlink signals with the baseband frequency, as with the first baseband processing unit 132. However, the second radio processing unit 141 and the second baseband processing unit 142 also perform a process not defined in the wireless communication standard with which the first data communication device 13 comply but defined in the wireless communication standard with which the second data communication device 14 comply. For example, the second baseband processing unit 142 also performs a spreading process to the uplink signals and a despreading process to the downlink signals.

The memory unit 15 includes a volatile semiconductor memory circuit and a non-volatile semiconductor memory circuit. The memory unit 15 stores, for example, various application programs to be executed on the processor 11, and data utilized by the application program and the like.

Furthermore, the memory unit 15 stores a flag indicating the set operational mode. Furthermore, the memory unit 15 stores the connection information while the mobile station 1 is performing the wireless communication with any of the base stations, and during the holding period after the mobile station 1 has moved outside the cell covered by the base station with which the mobile station 1 performed the wireless communication.

The communication control unit 16 includes at least one processor and a memory. The communication control unit 16 performs a connection setting process in accordance with the procedure defined in the wireless communication standard with which the base station complies, when the mobile station 1 starts the wireless communication with any of the base stations. The communication control unit 16 performs handover, transmission power control, a determination process of the modulation manner for the uplink signal and so on, during execution of the active mode which is a state where data is transmitted and received between the mobile station 1 and the base station.

Furthermore, the communication control unit 16 sets the holding period according to the operational mode set for the mobile station 1.

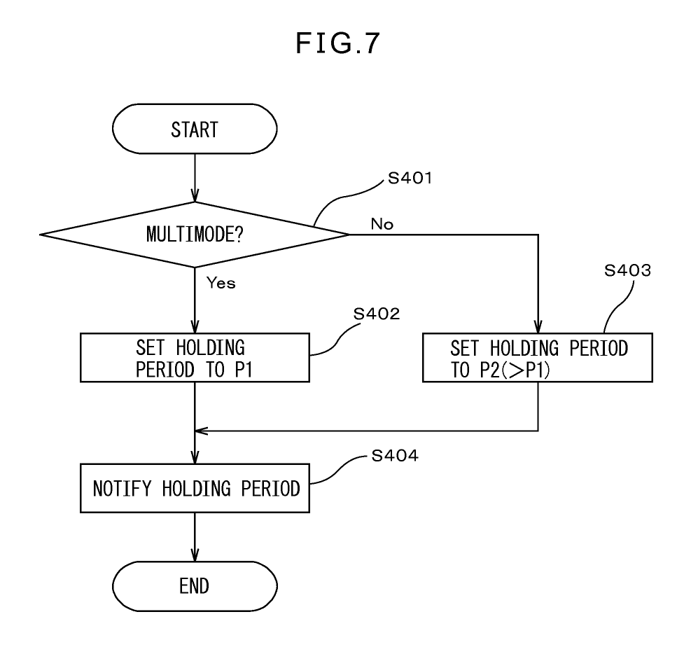

FIG. 7 is an operational flowchart of a setting process of the holding period, which is controlled by the communication control unit 16.

The communication control unit 16 determines whether or not the operational mode is the multimode, with reference to the flag indicating the operational mode stored in the memory unit 15 (step S401). When the operational mode is set as the multimode (step S401—Yes), the communication control unit 16 sets the holding period to P1 (for example, 5 seconds). On the other hand, when the operational mode is set as the dedicated mode (step S401—No), the communication control unit 16 sets the holding period to P2 (for example, 50 seconds) which is longer than P1 (step S403). In that case, the communication control unit 16 may sets the holding period corresponding to the set operational mode by, for example, referring to a reference table which represents correspondence relation between the operational mode and the holding period. Such reference table is stored into the memory unit 15 in advance, for example.

After the step S402 or S403, the communication control unit 16 generates a message which includes the parameter indicating the holding period and transmits the message by adding to the uplink signal, to thereby notify the base station for high speed communication 2 of the holding period (step S404).

After the step S404, the communication control unit 16 ends the holding period setting process.

When the operational mode is the multimode, the communication control unit 16 switches the base station, with which the data communication is performed, in accordance with whether or not the mobile station 1 is in the cell covered by the base station for high speed communication 2. For example, in a state where the mobile station 1 performs the data communication with the base station for high speed communication 2, if the mobile station 1 moves outside the cell covered by the base station for high speed communication 2 and the holding period P1 has elapsed after the mobile station 1 moved outside the cell, the communication control unit 16 deletes the connection information for communicating with the base station for high speed communication 2 from the memory unit 15. Then, the communication control unit 16 starts data communication with the base station for low speed communication 4. Subsequently, if the mobile station 1 moves into the cell covered by the base station for high speed communication 2, the communication control unit 16 switches the destination of the data communication from the base station for low speed communication 4 to the base station for high speed communication 2. In addition, if the mobile station 1 moved outside the cell covered by the base station for high speed communication 2 and the mobile station 1 moves into this cell within the holding period P1, the communication control unit 16 resumes a former communication session utilizing the connection information stored in the memory unit 15.

On the other hand, when the operational mode is the dedicated mode, the holding period P2 has elapsed after the mobile station 1 moved outside the cell covered by the base station for high speed communication 2, the communication control unit 16 also deletes the connection information for communicating with the base station for high speed communication 2 from the memory unit 15. Subsequently, if the mobile station 1 moves into the cell covered by the base station for high speed communication 2, the communication control unit 16 starts a new session with the base station for high speed communication 2 and also newly generates connection information. In addition, if the mobile station 1 moved outside the cell covered by the base station for high speed communication 2 and the mobile station 1 moves into this cell within the holding period P2, the communication control unit 16 resumes a former communication session utilizing the connection information stored in the memory unit 15. As described above, the holding period P2 for the case where the operational mode is the dedicated is set longer than the holding period P1 for the case where the operational mode is the multimode.

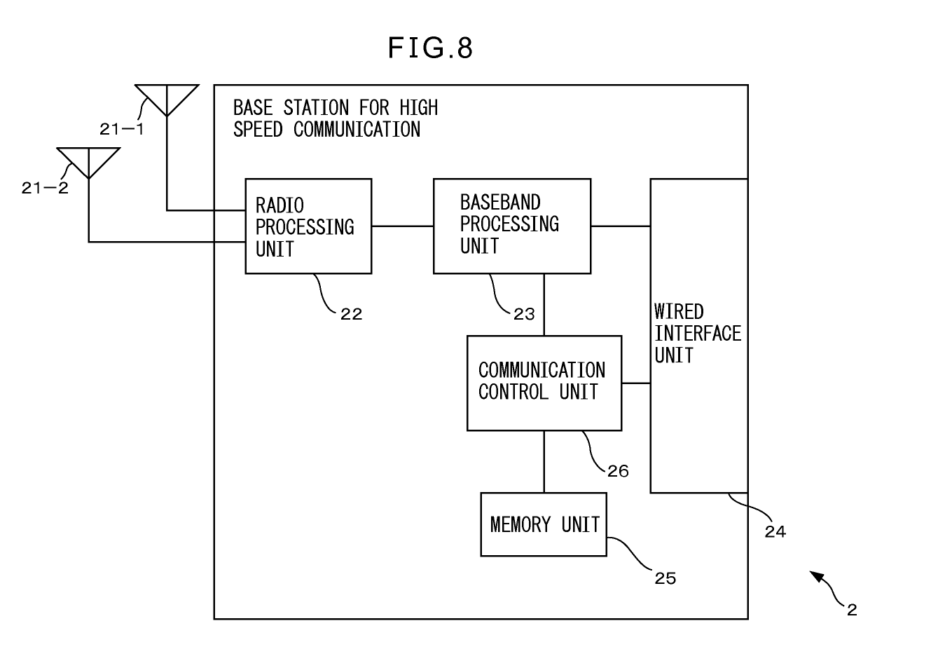

FIG. 8 is a schematic diagram of the base station for high speed communication 2. The base station for high speed communication 2 includes antennae 21-1, 21-2, a radio processing unit 22, a baseband processing unit 23, a wired interface unit 24, a memory unit 25, and a communication control unit 26.

The radio processing unit 22, the baseband processing unit 23, the memory unit 25, and the communication control unit 26 may be individual circuits respectively. Alternatively, each of units may be one integrated circuit in which those circuits are integrated.

The radio processing unit 22 performs processes, such as amplification of the uplink signals and the downlink signals, digital/analog conversion and frequency conversion. On the other hand, the baseband processing unit 23 performs a process to the uplink signals and the downlink signals with baseband frequency.

The radio processing unit 22 and the baseband processing unit 23 have functions similar to the first radio processing unit 131 and the first baseband processing unit 132 of the mobile station 1 illustrated in FIG. 6, respectively. Therefore, the detailed explanation about the radio processing unit 22 and the baseband processing unit 23 is omitted.

The wired interface unit 24 includes a communication interface circuit for connecting the base station for high speed communication 2 to other apparatus located in the core network side such as the ASN-GW 3. The wired interface unit 24 transfers the downlink signals received from the ASN-GW 3 and the like to the baseband processing unit 23. The wired interface unit 24 also transfers control signals for the base station for high speed communication 2, which are received from the ASN-GW 3 and the like, to the communication control unit 26.

On the other hand, the wired interface unit 24 outputs the uplink signals received from the baseband processing unit 23 to the ASN-GW 3 and the like.

The memory unit 25 includes a rewritable non-volatile semiconductor memory or volatile semiconductor memory, for example. The memory unit 25 stores various kinds of information which are utilized for a control for the wireless connection with the mobile station, such as an identification number of the cell covered by the base station for high speed communication 2, radio frequency used in the cell and so on. The memory unit 25 may also store the uplink signals or the downlink signals temporarily. Furthermore, the memory unit 25 stores each holding period for each mobile station which is performing the wireless communication with own base station for high speed communication 2. The memory unit 25 stores the connection information while the base station for high speed communication 2 is performing the wireless communication with the mobile station 1 and until the holding period has elapsed after the mobile station 1 moved outside the cell covered by the base station for high speed communication 2.

The communication control unit 26 includes at least one processor and a memory. The communication control unit 26 performs a connection setting process in accordance with the procedure defined in the wireless communication standard with which the base station for high speed communication 2 complies, when the mobile station 1 starts the wireless communication with the base station for high speed communication 2. The communication control unit 26 performs handover, transmission power control, a determination process of the modulation manner for the downlink signals and so on, during the wireless communication with the mobile station 1.

Furthermore, the communication control unit 26 sets the holding period based on the message indicating the holding period which is notified from the mobile station 1.

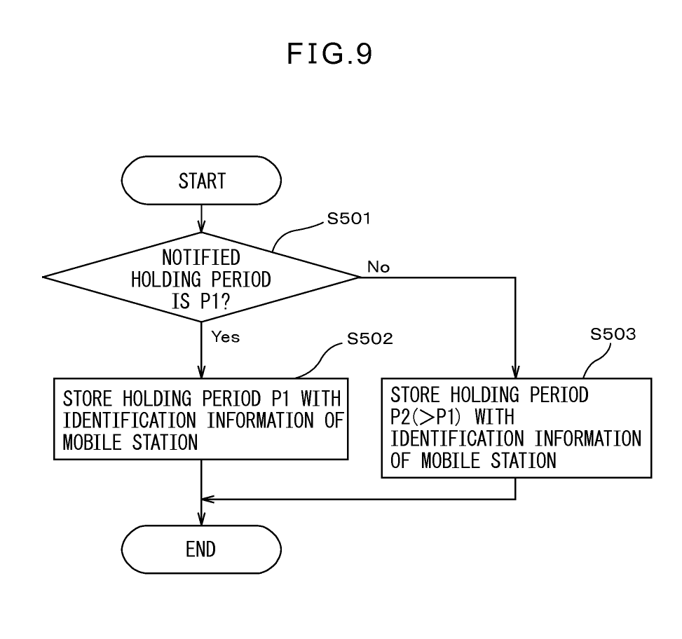

FIG. 9 is an operational flowchart of a setting process of the holding period, which is controlled by the communication control section 26.

The communication control unit 26 determines whether or not the holding period is P1, with reference to the parameter indicating the holding period which is included in the message received from the mobile station 1 (step S501). If the holding period is P1 (step S501—Yes), the communication control unit 26 sets the value of the parameter indicating the holding period to the value corresponding to P1 and stores the parameter in the memory unit 25 with the identification information of the mobile station 1 (for example, a MAC address of the mobile station 1) (step S502). On the other hand, if the holding period is P2 (step S501—No), the communication control unit 26 sets the value of the parameter indicating the holding period to the value corresponding to P2 and stores the parameter in the memory unit 25 with the identification information of the mobile station 1 (step S503).

After the step S502 or S503, the communication control unit 26 ends the holding period setting process and notifies the set holding period to other equipment in the radio access network 7 for high speed communication. The communication control unit 26 may send back a message including the parameter indicating the set holding period to the mobile station 1.

In a state where the mobile station 1 performs the data communication with the base station for high speed communication 2, if the mobile station 1 moves outside the cell covered by the base station for high speed communication 2 and the holding period has elapsed after the mobile station 1 moved outside the cell, the communication control unit 26 deletes the connection information regarding to the mobile station from the memory unit 25. After that, if the mobile station 1 moves again into the cell covered by the base station for high speed communication 2, the communication control unit 26 starts a new communication session with the mobile station 1. In addition, if the mobile station 1 moved outside the cell covered by the base station for high speed communication 2 and the mobile station 1 moves into this cell within the set holding period, the communication control unit 26 resumes the former communication session utilizing the connection information stored in the memory unit 25.

As explained above, the mobile communication system sets the holding period for the case where the mobile station is set as the multimode to be shorter than the holding period for the case where the mobile station is set as the dedicated mode. Accordingly, if the mobile station switches a communication path to a communication path via the base station for low speed communication right after the mobile station has moved outside the cell covered by the base station for high speed communication, the base station for high speed communication can release the resource assigned to the mobile station at an early stage. Therefore, the base station for high speed communication can improve efficient use of a resource.

It is only necessary to set the holding period of the connection information for the mobile station to connect with the base station for low speed communication is set to a predetermined period (for example, for 10 seconds). When the mobile station which is set as the multimode is unable to perform the communication with the base station for low speed communication, the mobile station and the base station for low speed communication discard the connection information at the time where the holding period has elapsed after becoming unable to perform the communication.

Moreover, according to another modification, the areas of the two base stations in which the mobile station can communicate may be different each other, whereas the communication speed of the two base stations may be the same.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A mobile communication system comprising:
a mobile station, a first base station and a second base station other than the first base station,
wherein the mobile station notifies the first base station of a first holding period when a first mode, in which the mobile station selects one of the first base station and the second base station and performs wireless communication with the selected base station, is set, while notifies the first base station of a second holding period which is longer than the first holding period when a second mode, in which the mobile station performs wireless communication with the first base station and does not performs wireless communication with the second base station, is set, and
wherein the first base station discards connection information used for connecting the mobile station with the first base station at the time when the first holding period has elapsed after the mobile station has become unable to perform the wireless communication with the first base station when the first holding period is notified from the mobile station, and on the other hand, discards the connection information at the time when the second holding period has elapsed after the mobile station is unable to perform the wireless communication with the first base station when the second holding period is notified from the mobile station.

2. The mobile communication system according to claim 1, wherein the mobile station adds a parameter indicating the first holding period to a first message, the first message for requesting to the first base station to transit into an idle mode in which radio signals from the first base station are received for every predetermined cycle, when the first mode is set, while adds the parameter indicating the second holding period to the first message when the second mode is set, to thereby notify the first base station of the first holding period or the second holding period.

3. The mobile communication system according to claim 1, wherein the mobile station adds a parameter indicating the first holding period to a second message, the second message for notifying communication capability of the mobile station in order to initiate the connection with the first base station, when the first mode is set, while adds the parameter indicating the second holding period to the second message when the second mode is set, to thereby notify the first base station of the first holding period or the second holding period.

4. The mobile communication system according to claim 1, wherein the mobile station adds a parameter indicating the first holding period to a third message when the first mode is set, and on the other hand, adds the parameter indicating the second holding period to the third message when the second mode is set, and transmits the third message during the wireless communication with the first base station, to thereby notify the first holding period or the second holding period.

5. The mobile communication system according to claim 1, wherein when the mobile station transits into an idle mode in which radio signals from the first base station are received for every predetermined cycle, the first base station sets the predetermined cycle to a first calling cycle and notifies the mobile station of the first calling cycle when the first holding period is notified, while the first base station sets the predetermined cycle to a second calling cycle which is shorter than the first calling cycle and notifies the mobile station of the second calling cycle when the second holding period is notified.

6. A mobile station communicating with a first base station or a second base station other than the first base station, comprising:
a user interface unit which sets one of a first mode in which one of the first base station and the second base station is selected and wireless communication is performed with the selected base station and a second mode in which wireless communication is performed with the first base station and is not performed with the second base station;
a memory unit which stores connection information used for connecting the mobile station with the first base station; and
a communication control unit which deletes the connection information from the memory unit at the time when a first holding period has elapsed after the mobile station is unable to perform the wireless communication with the first base station when the mobile station is set to the first mode, while deletes the connection information from the memory unit at the time when a second holding period which is longer than the first holding period has elapsed after the mobile station is unable to perform the wireless communication with the first base station when the mobile station is set to the second mode.

7. The mobile station according to claim 6 wherein the communication control unit adds a parameter indicating the first holding period to a message notifying to the first base station when the mobile station is set to the first mode, while adds the parameter indicating the second holding period to the message when the mobile station is set to the second mode.

8. A base station capable of performing wireless communication with a mobile station, comprising:
a memory unit which stores connection information used for connecting the mobile station with the base station and a holding period notified from the mobile station; and
a communication control unit which deletes the connection information from the memory unit at the time when the holding period has elapsed after the mobile station is unable to perform the wireless communication with the base station.

9. A method for setting a holding period of connection information for connecting a mobile station with a first base station in a mobile communication system comprising the mobile station, the first base station and a second base station other than the first base station, the method comprising:
the mobile station notifies the first base station of a first holding period when a first mode, in which the mobile station selects one of the first base station and the second base station and performs wireless communication with the selected base station, is set, while notifies the first base station of a second holding period which is longer than the first holding period when a second mode, in which the mobile station performs wireless communication with the first base station and does not performs wireless communication with the second base station, is set; and
the first base station, when the first holding period is notified from the mobile station, sets a period until discarding the connection information after the mobile station is unable to perform the wireless communication with the first base station to the first holding period, and when the second holding period is notified from the mobile station, sets the period until discarding the connection information after the mobile station is unable to perform the wireless communication with the first base station to the second holding period.
